(19) United States
(12) Patent Application Publication
(10) Pub. No.: US 2009/0220666 A1
(43) Pub. Date: Sep. 3, 2009

(54) Utilization of stabilized bran in high protein products

(76) Inventors: Leo Gingras, Scottsdale, AZ (US); Paul Mathewson, Scottsdale, AZ (US)

Correspondence Address: MCDERMOTT, WILL & EMERY LLP;Attn: IP Department, 227 WEST MONROE STREET, SUITE 4400, CHICAGO, IL, 60606-5096, US

(21) Appl. No.: 12/378,154

(22) Filed: Feb. 11, 2009

Related U.S. Application Data
(60) Provisional application No. 61/027,797, filed on Feb. 11, 2008.
(60) Provisional application No. 61/125,731, filed on Apr. 25, 2008.
(60) Provisional application No. 61/127,913, filed on May 16, 2008.

(51) Int. Cl. A23L 1/317

(52) U.S. Cl. 426/574; 426/646

(57) ABSTRACT

The present invention relates to meat product compositions, including meat analog products, including at least one type of bran material as a meat extender. Use of the bran material, such as a stabilized rice bran, provides an extender with added nutritional and cost-effective benefits, while retaining the organoleptic properties of the resulting meat product or meat analog product composition.

### CROSS-REFERENCE TO RELATED APPLICATIONS

This application claims priority to U.S. Provisional Application No. 61/027,797, filed Feb. 11, 2008, U.S. Provisional Application No. 61/125,731 filed on Apr. 25, 2008, and U.S. Provisional Application No. 61/127,913 filed on May 16, 2008 which are hereby incorporated by reference.

### FEDERALLY SPONSORED RESEARCH OR DEVELOPMENT

None

### TECHNICAL FIELD

The present invention relates to the use of stabilized bran products and their use as extenders and fillers in a variety of high protein products. More specifically, the bran products include stabilized rice bran, stabilized wheat bran and/or combinations of stabilized rice bran and stabilized wheat bran. Bran materials suitable for this purpose are stabilized bran material with full fat content, partially defatted-stabilized bran material or fully defatted bran material. Stabilized bran products are useful as extenders, either alone or in combination with known extenders, in a variety of high protein products, such as meat products and meat analog products with 100% protein derived form vegetable sources.

### BACKGROUND OF THE INVENTION

The use of extenders or substitutes in meat products has been common practice in many areas of the world for thousands of years. While many people in less developed areas of the world subsist largely on vegetable protein such as that found in soybean, it is understood that as disposable income levels rise, demand for animal products increases and vegetable consumption declines. For example, in spite of the fact that the Japanese and Chinese have utilized soybeans as a major source of protein for several thousand years, they have recently increased their consumption of animal protein both through indigenous animal production and importation of meat, poultry and dairy products.

Desirable animal-derived protein tends to be expensive relative to vegetable protein. Thus, in the last few decades there has been a significant increase in production and consumption of meat extenders. The first commercial meat extenders were derived from defatted soy flour and corn grits because of their high nutritional value, excellent water binding and emulsifying properties and relatively low cost. Vegetable products used to extend meats and lower costs were first permitted in meats in 1945 under federal meat inspection guidelines.

Currently the most widely used vegetable-derived meat extender comes from soybean products. Soy protein isolate is a vegetable-based protein that is very commonly used in meat extender compositions. It is highly water soluble, has a high nutritive value, provides emulsification characteristics amenable to many meat compositions and provides the desirable cost advantage relative to meat. In addition, the extenders for use in meat products are also derived from whey proteins and wheat gluten.

The wide spread use of meat extenders may be attributed to improved production and processing technology, advanced methods to improve flavor technology and, of course, the favorable price of vegetable-derived protein compared with meat protein. However, there are still opportunities to improve on whey or soy protein-based extender compositions to further enhance a meat extender formulation. Use of a supplemental source of protein, carbohydrate and oil which could provide similar functionality at a lower cost and with an improved nutritional profile would make available a meat extender component that could beneficially replace a portion of the whey or soy protein-based extender. Moreover, with the increasing worldwide demand for meat products and meat analog products, there is a need for discovering and developing new extenders and fillers that would retain the original palatability of the meat product or meat analog and at the same time offer a cost advantage over the extenders already existing in the market place. The compositions and methods of the present invention meet these needs and provide related advantages as well. Use of bran materials, particularly stabilized rice bran material, as a meat extender provides these advantages.

The nutritional value of stabilized rice bran has been well recognized. Use of stabilized rice bran in treatment of a number of human ailments, such as diabetes, coronary diseases, arthritis, and cancer, have been described in the following commonly-owned U.S. Patents and Patent Application Publication including: U.S. Pat. No. 5,985,344, entitled, “Process for Obtaining Micronutrient Enriched Rice Bran Oil;” U.S. Pat. No. 6,126,943 entitled, “Method for Treating Hypercholesterolemia, Hyperlipidemia, and Atherosclerosis;” U.S. Pat. No. 6,303,586 entitled, “Supportive Therapy for Diabetes, Hyperglycemia and Hypoglycemia;” U.S. Pat. No. 6,558,714, entitled “Method for Treating Hyper cholesterolemia, Hyperlipidemia, and Atherosclerosis;” U.S. Pat. No. 6,733,799 entitled “Method for Treating Hypercholesterolemia, Hyperlipidemia, and Atherosclerosis;” U.S. Pat. No. 6,902,739, entitled “Method for treating Joint Inflammation, Pain, and Loss of Mobility;” and U.S. Patent Application Publication US 2008/0038385 entitled “Therapeutic uses of an anti-cancer composition derived from rice bran.” Each of the foregoing patents are hereby incorporated by reference in its entireties.

Previously, rice bran and more particularly the stabilized rice bran (“SRB”) has not been used as an extender for high protein products, such as meat products or meat analogs. Historically, preserving rice bran for general consumption was not feasible. With traditional milling methods, lipase enzyme renders the bran and germ rancid in a matter of hours. Lipase enzyme, which exists naturally in the bran layer, comes in contact with the bran's oil and begins rapid degradation of the bran within hours after removing the bran from rice kernel. This degradation results in a rice bran with a short shelf life and, therefore, little commercial value. Without a stabilization process, the powerful array of vitamins, minerals, phytosterols and antioxidants present in the rice bran is unavailable because the rancid rice bran is unpalatable and not consumed by humans. Stabilization of rice bran can be accomplished via many known methods.

The SRB produced through an appropriate stabilization process meets the requirement for being a good meat extender. Stabilized rice bran possesses high nutritional value along with a good water binding capacity due to its high fiber content, and a good emulsifying capability due to its high oil content. In addition, since rice bran is considered as a byproduct of current rice milling operation, SRB can be produced at a relatively low cost. Thus, SRB may be used to replace some or all of the currently used meat extenders such as soy protein isolate while maintaining product quality at a reduced cost. The SRB may also be used in meat analog products. Surprisingly, the addition of a small amount of a stabilized bran material to a high protein product will provide a nutritionally-enhanced meat product with a definite cost saving, while retaining the desirable organoleptic properties of the high protein products.

### BRIEF SUMMARY OF THE INVENTION

The present invention relates to novel composition high protein products namely the meat products and meat analogue products. The present invention provides a cost-effective composition that can be used as an extender with meat products and meat analog products in place of currently used meat extender compositions.

In one embodiment, the present invention provides a meat product comprising a blend of at least one meat and a meat extender wherein the meat extender comprises bran material. The bran material suitable for this present invention is a stabilized bran material, either fully-fatted or defatted, derived either form a cereal grain or an oil seed.

In yet another embodiment, the present invention provides a meat product having an extender component comprising a combination of bran materials derived from more than one source. The stabilized bran may be selected from the group consisting of stabilized rice bran, stabilized wheat bran and combinations of stabilized rice bran and stabilized wheat bran.

In still another embodiment, the present invention provides a meat product including a bran material and an additional extenders selected from a group consisting of texturized vegetable proteins, whey-based meat extender, milk-based meat extender, and meat extender derived form cereal grains and cereal flours.

In yet another embodiment, the present invention provides a meat analog product comprising a bran material. The bran materials may be derived from cereal grains or oil seeds.

In still another embodiment, the novel meat product or meat analog product comprises a composition of a stabilized bran and non-protein components such as spices and flavoring to enhance taste and acceptability of the finished product.

In yet another embodiment, the present invention provides a meat product or a meat analog product comprising stabilized rice bran. In a more preferred embodiment, the present invention provides a meat product or a meat analog product comprising a combination of stabilized rice bran and a stabilized wheat bran materials.

### BRIEF DESCRIPTION OF DRAWINGS

FIG. 1 shows the fat, protein and moisture content of control and experimental frankfurters made with amounts of stabilized rice bran ranging from 0.5% to 3.5%. The values are expressed as percentage of total weight of the cooked frankfurters.

FIG. 2 shows the cooked yield of control and experimental frankfurters made with amounts of stabilized rice bran ranging from 0.5% to 3.5%.

FIG. 3 shows the purge rate of control and experimental frankfurters prepared with amounts of stabilized rice bran ranging from 0.5% to 3.5%. The purge rate for three different time periods (2 weeks, 6 weeks and 12 weeks) are shown.

FIG. 4 shows the skin and core texture values in grams/cm³ for control and experimental frankfurters made with amounts of stabilized rice bran ranging from 0.5% to 3.5%.

FIG. 5 shows the interior and exterior color values for control and experimental frankfurters made with amounts of stabilized rice bran ranging from 0.5% to 3.5%. Shown in the figure are three set of values (L, a, and b) for both exterior and interior colors. In each group, there are eight columns and the vertical axis of each column represents the color value for a particular frankfurter preparation. In each group, the left most column represents the color value for the control frankfurter preparation without any added stabilized rice bran. Columns 2 through 8 in each group represent experimental frankfurter formulations with increasing stabilized rice bran concentrations ranging from 0.5% to 3.5%. The second column in each group is frankfurter formulation with 0.5% stabilized rice bran. The eighth column in each group is frankfurter formulation with 3.5% stabilized rice bran.

FIG. 6 shows the aroma value for control and experimental frankfurters made with amounts of stabilized rice bran ranging from 1.0% to 3.5%. Aroma values are provided in a Hedonic scale for three different time periods of Day 1, Day 45, and Day 90.

FIG. 7 shows the meat flavor values for control and experimental frankfurters made with amounts of stabilized rice bran ranging from 1.0% to 3.5%. Flavor values are provided in a Hedonic scale for three different time periods of Day 1, Day 45, and Day 90.

FIG. 8 shows the meat color values for control and experimental frankfurters made with amounts of stabilized rice bran ranging from 1.0 to 3.5%. Meat color values are provided in a Hedonic scale for three different time periods of Day 1, Day 45, and Day 90.

FIG. 9 shows the interior firmness values for control and experimental frankfurters made with amounts of stabilized rice bran ranging from 1.0 to 3.5%. Interior firmness values are provided in a Hedonic scale for three different time periods of Day 1, Day 45, and Day 90.

FIG. 10 shows the interior cohesion values for control and experimental frankfurters made with amounts of stabilized rice bran ranging from 1.0 to 3.5%. Interior cohesion values are provided in a Hedonic scale for three different time periods of Day 1, Day 45, and Day 90.

FIG. 11 shows the interior uniformity values for control and experimental frankfurters made with amounts of stabilized rice bran ranging from 1.0 to 3.5%. Interior uniformity values are provided in a Hedonic scale for three different time periods of Day 1, Day 45, and Day 90.

FIG. 12 shows the juiciness values for control and experimental frankfurters made with amounts of stabilized rice bran ranging from 1.0% to 3.5%. Juiciness values are provided in a Hedonic scale for three different time periods of Day 1, Day 45, and Day 90.

FIG. 13 shows the cooked yield value for control chicken nuggets and chicken nugget preparations made with 2% and 3.5% stabilized rice bran.

### DETAILED DESCRIPTION OF THE INVENTION

Before the present stabilized bran-containing food products and method of making thereof are disclosed and described, it is to be understood that the invention is not limited to the particular configuration, process steps, and materials disclosed herein as such configuration, process steps, and materials may vary somewhat. It is also to be understood that the terminology employed herein is used for the purpose of describing particular embodiments only and is not intended to be limiting since the scope of the present invention will be limited only by claims and equivalents thereof.

As used herein the term “meat” includes not only animal tissue such as would be recognized as “meat” by the consumer, particularly skeletal meats, but also that broader class of animal products recognized as meat by food processing industry. The meat may be derived from any animal which is capable of being consumed by humans and other animals, whether or not it is actually commonly used as a food source at the present time. The list of the meat for human or animal consumption includes, but not limited to, beef, pork, veal, liver, poultry, fish, organ meats, such as liver and the like, and game, such as venison, and the like.

The term “meat extender” includes the materials from plant sources that can be added to a meat, generally ground meat, for the purpose of cost saving by substituting costlier meat with a less expensive plant materials.

The term “meat products” may include products made from meat that commonly incorporate binders, fillers and/or extenders therein. Examples of meat products made pursuant to the present invention include, but are not limited to, emulsified or comminuted meat products, such as hot dogs, bologna and the like, coarse chopped meat products, including but not limited to hamburger, chicken nuggets and the like, whole muscle meat products, including but not limited to ham, turkey breast, roast beef and the like, and hard fermented sausages such as salami and the like.

The term “meat analog” refers to meat-like vegetable protein products. Examples include vegetable burger patties prepared from vegetable protein based products which are palatable, bland, and light colored with meat-like texture. Meat analog also includes jerky products produced with proteins source selected from non-meat source such as dairy protein isolate, legume isolates, cereal isolate including wheat gluten, canola isolate, cotton seed isolate, soy isolate, sunflower seed isolate and mixtures thereof with soy protein isolate being preferred. Known methods to process whole soybeans into textured proteinaceous materials having meat-like texture and appearance involve acidifying whole soybeans and grinding in aqueous medium to provide an aqueous slurry or dough of soybean particles. The slurry is passed through high temperature pressurized steam under conditions that effect texturization of the soy protein in the form of discrete chunks or pieces. The texturized pieces are dried and re-hydrated for use in a wide variety of food products. Additives such as flavoring, coloring, fat seasoning and other proteinaceous materials may be incorporated in the texturized soy protein pieces.

As used herein, the meat analogs of the present invention include novel food materials produced from plant materials having a texture resembling that of natural meat. Since natural meat products are generally considered to be composed of muscular fibers, efforts have been made to obtain meat analogs having a fibrous or shred-like texture like that of natural meat. A variety of techniques have been developed for producing such food materials, for example, as discussed in U.S. Pat. No. 4,863,749 and U.S. Pat. No. 6,613,369.

Plant-derived proteins and carbohydrates have increased functionality, a bland flavor profile, additional nutritional benefits, and a low-cost advantage and are increasingly used as meat extenders and meat analogs. Advances in processing technology have enabled development of new ingredients to enhance many types of foods through improved emulsification, water binding, texture modification and flavor enhancement, all at an economically competitive price.

The physical properties of protein-containing foods such as meat, poultry, seafood, eggs and dairy products are defined to a large extent by their protein composition. The functional properties of some plant-derived proteins have the ability to mimic or parallel the physical properties of products like meat under certain conditions and formulations. Through technological advances, many plant protein characteristics have been altered to the extent of even imitating meat products.

Meat extenders have been used for many years as supplements to the muscle meats and more particularly, ground muscle meats. The use of meat extenders has been prompted by a gradual trend away from eating meat protein alone as well as by economic drivers to make animal meat less expensive and therefore, available to more people. Meat extender compositions are generally comprised of mixtures containing vegetable-based protein, starch, gums and other functional components as well as a variety of flavor and texture enhancers. Characteristics of the extender mixture tend to be defined by high protein content, good water binding capacity, ability to emulsify the water and fat components of the meat composition, and provide a cost advantage relative to the primary meat portion.

In the United States, there are two categories of meat products namely standard of identity meat products and meat products which are not standard of identity meat products. The use of meat extenders and binders is limited to 3.5% of the total meat product in standard of identity meat products. However, in the meat products that are not standard of identity meat products, the extender addition can exceed the limit of 3.5%. Moreover, in other countries of the world the use of such products can vary widely as a percentage of the meat composition. Although certain standard of identity meat products have limitations with respect to the total amount of extender that may be incorporated therein, the present invention contemplates that the stabilized bran may be incorporated into meat products or meat analog products at higher concentrations than dictated by the various rules for standard of identity products.

Unlike typical meat extenders, rice bran is rich in fiber and has only 15% protein by weight. Surprisingly, rice bran material such as that used in the present invention, which is rich in fiber, is able to function as a meat extender without disrupting the organoleptic and functional properties of the resulting meat product.

Rice bran is the outer layer of brown rice. The bran layer makes up about 8 to 10% of the rough rice and is an excellent source of protein, vitamins and minerals, oil and fiber. Abundant amount of rice bran is obtained in the rice milling operations. At present about 60 million tons of rice bran is produced in the world annually.

Rice bran obtained in the second stage of rice milling is composed of 4-8% water, 18-21% oil, 14-16% protein, 23-28% dietary fiber, 7-10% ash and 45-55% carbohydrate. Despite this highly nutritious composition, rice bran is not widely used for human consumption due to its quick degradation. Rice bran is very rich in lipases that hydrolyze the oil in the bran into glycerol and fatty acids leading to a development of rancid smell and taste typically within hours after its production.

The bran stabilization process takes the raw rice bran as it is removed during the milling process and inactivates enzymes that cause rancidity. The result is a highly nutritious ingredient with a relatively long shelf life. Stabilized rice bran can be further processed into bran derivative products such as soluble fraction and insoluble fraction which are enriched in certain nutritional components. The soluble fraction is enriched in oil and protein components while the insoluble fraction is enriched in fiber component. These derivative bran fractions can also be used as extenders in meat products.

In recent years, efforts have been made to inactivate the lipase in the rice bran and thereby produce stabilized rice bran (SRB). The stabilization of bran materials, particularly the stabilization of rice bran, can be achieved by following a number of procedures, including chemical and heat treatments known in the art. See, for example, U.S. Pat. No. 5,292,537 and U.S. Pat. No. 6,245,377.

The nutritional value of SRB is well recognized. Rice bran has a unique blend of a high fat, high fiber and high protein that makes it well-suited for use as an extender for meat products or meat analog products. The fat component helps to ensure that the temperature rises quickly in the cooked product and enhances the mouth feel and texture of the finished product. Water is generally added to processed meats to retain the moisture that is lost in the curing/cooking process. The addition of water also helps to maintain the moist touch and mouth-feel desirable in the finished meat product. The high fiber in rice bran helps to bind and retain the water in the finished product. In addition, stabilized rice bran and its derivatives are rich in antioxidants, E and B vitamins and other micronutrients that may help to prevent oxidation and contribute positively to the overall nutritional profile of the meat product. Stabilized rice bran is utilized herein as an effective extender or component thereof for meat products and/or meat analog products, as described below. The bran material suitable for this purpose may be stabilized full-fat rice bran or stabilized-partially defatted rice bran or fully defatted rice bran.

Wheat bran is also a potential extender for meat products and/or meat analogs. On a weight basis, wheat bran has 3% fat, 65% carbohydrate including 43% dietary fiber and 16% protein. As is the case with rice bran, wheat bran is rich in lipase. In the wheat kernel, lipase is found almost exclusively in the bran/germ component. As a result the bran containing wheat flour is much more susceptible to the development of rancidity. Stabilization of wheat bran can be achieved by using a mechanical extrusion process as described in the commonly-owned, co-pending U.S. Utility patent application Ser. No. 12/316,312. Stabilized wheat bran typically has a shelf life of six months to one year.

The present invention describes the use of stabilized bran such as stabilized rice bran, stabilized wheat bran and/or combinations of stabilized rice bran and stabilized wheat bran. The stabilized bran may be a stand-alone extender or as a component of extender compositions including other types of currently used meat extenders such as soybean or whey protein based meat extenders. Meat products to which an extender composition may be added are usually a ground meat.

The extenders of the present invention further include various proteins, starches, spices and seasonings to give increased bulk to the ground meat, thereby enabling preparation of a greater volume serving using less meat. The ground meat products containing these compositions may deliver enhanced levels of protein in a more digestible form than the meat itself. When used in ground meat, the extender may also provide a moist texture, while retaining the natural color and flavor.

The extender compositions of the present invention comprise both a stand-alone extender, such as stabilized rice bran, as well as, a mixture of stabilized bran and a plant-based extender composition, which may include component such as soy, whey protein isolate, starch, maltodextrin and non-fat dry milk. The extender composition may also include additional spices and flavor modifiers to further enhance the organoleptic qualities of these meat products. These may include, for example, seasonings and spices, such as onion or garlic powder, mustard flour salt, pepper, vegetable oil, corn starch and tapioca starch, non-hygroscopic dried whey and the like. When all the ingredients are combined, a free flowing powder is prepared. Amounts of these ingredients are based on the requirements of the finished product.

An embodiment of the present invention involves the utilization of stabilized bran as a component of a standard meat extender composition in which all or a portion of the meat extender is replaced with stabilized bran. For example, a soy protein isolate-based extender composition containing soy protein isolate, xanthan or locust bean gum and water is commonly used as a meat extender for ground meats. A suitable substitute product may be formulated by replacing, for example, 10% of the soy protein isolate with stabilized bran. It is believed that a stabilized bran-containing extender would provide equivalent sensory and functional quality at a lower cost relative to an extender having 100% soy protein isolate. Depending on the application, a stabilized bran meat extender may be formulated by replacing from 1% to 100% of the soy protein isolate, more preferably from 1% to 50% of the soy protein isolate and most preferably, 5% to 25% of the soy protein isolate. The extender, therefore, may comprise 100% stabilized bran, a portion of stabilized bran and a starch component, or a portion of stabilized bran, a starch component and soy protein isolate. The stabilized bran suitable for this purpose is stabilized rice bran, stabilized wheat bran or combinations of stabilized rice bran and stabilized wheat bran.

A further advantage of replacement with stabilized bran of a portion of either the protein and/or carbohydrate portions of the standard meat extender is that the stabilized bran has the property of binding to and enhancing the flavor components of the meat composition. Consequently, the flavor components added to the extender formulation can be minimized to further reduce costs associated with formulating a functional meat extender composition.

Thus, current meat extender compositions containing high protein plant-based materials such as whey or soy protein isolate, a carbohydrate portion consisting of starch, gums and other water-hydratable carbohydrates and various flavoring agents may be improved through the use of stabilized bran such as stabilized rice bran, stabilized wheat bran and/or combination thereof. The various features of rice bran such as high protein, high fat and high fiber content contribute important functional characteristics which help to improve the overall functionality of the meat extender. In addition to these functional characteristics, stabilized bran such as stabilized rice bran, stabilized wheat bran and combinations of stabilized rice bran and stabilized wheat bran, in particular, also contain antioxidants, B and E vitamins and other micronutrients that contribute positively to the overall nutritional profile of the finished meat product.

In any of the descriptive embodiments discussed herein, the partially defatted or fully defatted rice bran as well as partially defatted or fully defatted forms of stabilized wheat bran can be used. These embodiments may include products that contain some proportion of meat in combination with vegetable protein as well as all-vegetable protein meat replacement products (such as, for example, veggie-burger type products).

### Example 1

### Stabilized Rice Bran as an Extender in Frankfurter Preparation

In a first example of the present invention, SRB was used as a stand-alone meat extender in comminuted meat products. U.S. Pat. No. 6,126,943 incorporated herein by reference in its entirety, provides description of a source for SRB and the process for obtaining derivatives of SRB. It would be desirable that any SRB-based extender not adversely affect, among other characteristics, flavor and aroma profiles, juiciness, cohesiveness, interior uniformity and cured meat color. In addition, the SRB should not contribute to rancidity in the formulated meat product.

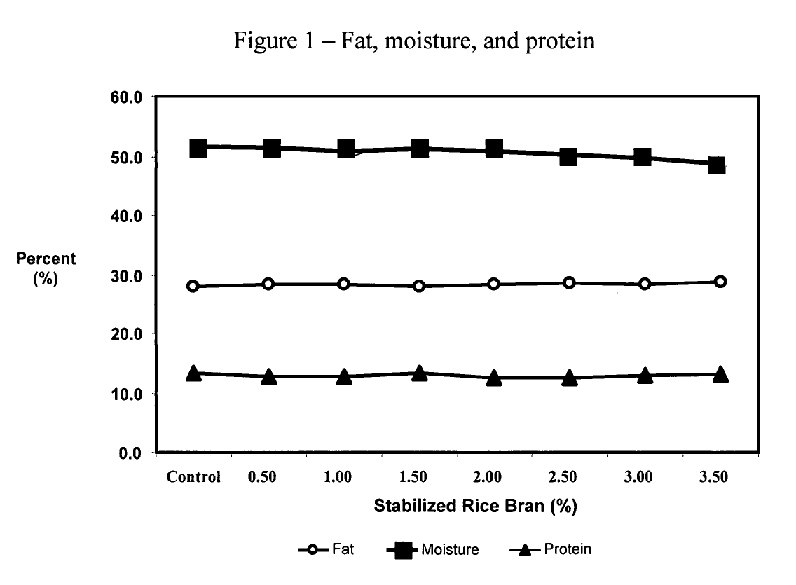

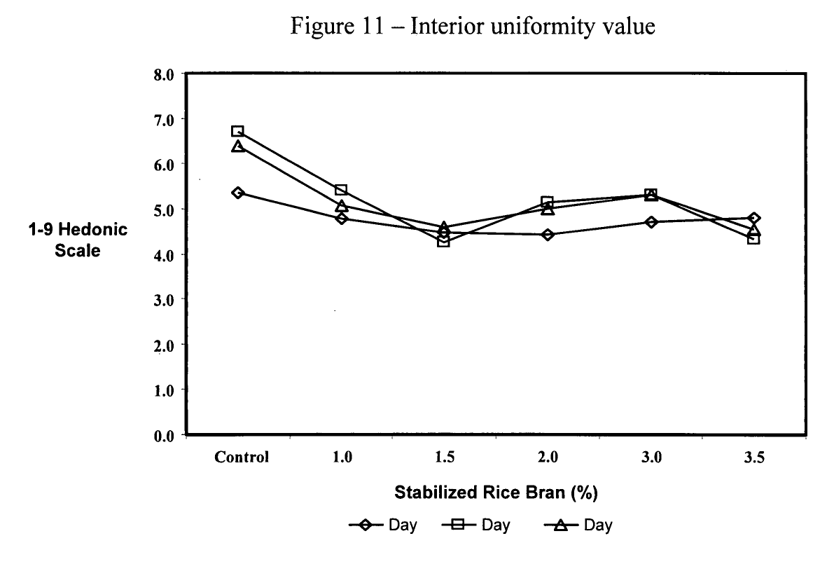

An extensive study was conducted in which SRB was used at various levels in a frankfurter formulations. In these studies, SRB was used as a stand-alone meat extender. The various compositions used in this example and the results are provided in Tables 1 and 2 and in the FIG. 1-12.

The objectives of the study were to evaluate the quality and sensory characteristics of standard frankfurters with varying levels of SRB added as a meat extender. The SRB inclusion levels extended from 0.5% to 3.5% by weight. Eight different formulations were prepared using a base formulation supplemented with SRB at levels from 0% (control) to 3.5% in 0.5% increments (Table 1).

Fresh pork (with 10% fat) and beef (with 50% fat) was obtained from Iowa State University Meat Laboratory. Stabilized rice bran was obtained from NutraCea. Eight formulations were formulated as shown in Table 1. The lean pork (with 10% fat) along with stabilized rice bran was chopped in a bowl chopper (Kramer and Grebe model VASM65, GmbH & Co. KG, Wallau/Lahn, Germany) with salt, sodium phosphate, sodium nitrite, sodium erythorbate and half the water to 4.4° C. (40° F.), then the beef, water and the dry ingredients were added. Chopping was continued until the batter reached 18° C. (64.4° F.). Meat batters were then stuffed (model RS 1000/65, Risco Brevetti, Zne-vi-Italy) into 22 mm diameter cellulose casings (Devro Teepak Summerville, S.C.) and smoked in an Alkart single truck smokehouse (Alkar, Lodi, Wis.) to an internal temperature of 71° C. (162° F.) using a standard smokehouse process. The cook cycle utilized natural smoke followed by increased humidity and finished off with a cold shower. After cooking, frankfurters were chilled for 24 hours, peeled and vacuum packaged (AG800, Sepp Haggenmuller KG, West Germany) in high oxygen pouches (Cryovac Sealed Air Corp., Duncan, S.C.) and kept in a cooler at 2° C. (35.6° F.) for subsequent evaluation. The entire experiment was replicated 3 times.

Both physical and sensory evaluations were conducted on the frankfurter products. The physical evaluations included measurements for proximate analysis, cooked yield, purge, texture and color. Sensory evaluations were conducted by a trained sensory panel using a hedonic scale of 1 to 9. For all evaluations, statistical significance was determined at the P<0.05 level.

Proximate analysis: The frankfurters were evaluated for moisture and fat using AOAC methods (Association of Official Analytical Chemists Official method of Analysis, 16th ed. 1993, Association of Official Analytical Chemists, Washington, D.C.). Protein was measured using a nitrogen analyzer (model FP-428, LECO Corporation, St. Joseph, Mich.). Measurements were done in duplicate.

Cooked yield: For each individual treatment, product cooked yield was calculated by dividing the chilled product weight 24 hours after removal from the smokehouse by the uncooked product weight (cooked product weight/uncooked product weight×100). Cooked yield, therefore represented product weight losses that occurred primarily during thermal processing and chilling.

Purge: Purge was measured at 2, 4, 6, 8, 10, and 12 weeks after manufacturing of the frankfurters. For each treatment, packages containing approximately 190 g of frankfurters were weighed before vacuum packaging. The samples were then removed from the bag, dried off with a paper towel and weighed. Purge was calculated as a percentage of the initial weight[(bag & product weight)·(bag weight)−(product weight)/(bag & Product weight)−(bag weight)]. Two packages from each treatment were used for purge measurement during each testing period.

Instrumental texture evaluation: Texture was measured using a TA-XT2 Stable Microsystems Texture Analyzer equipped with a ½″ diameter round probe. The product was heated inside the package by dipping the package in 90° C. water for 5 minutes to eating temperature before texture was measured. Skin texture measurements were done on the exterior of several frankfurters on 10 different locations and internal texture was measured on 10 cross sectional placed cut to 20 mm. Texture measurements were done by compressing both external skin and cross sectional pieces to 80% of the height. Peak load was measured in grams/cm³.

Instrumental color determination: Color determinations were made on the surface of the packaged frankfurters, as well as on the interior of the ground frankfurters by using a Hunter Lab DP-9000 equipped with D25 A Optical Sensor (Hunter Assoc. Laboratory Inc., Reston, Va.). Standardization was done by using the white and black standard plate. Packaging material was compensated for during instrument standardization by covering the white standard plate with a Ziploc® bag before standardization. Measurements were taken directly on the surface of the packaged frankfurter on a 3 different locations. Measurements were also taken directly on the surface of the ground frankfurter which was placed in a Ziploc® bag. Samples were measured for “L”, “a”, and “b” values. Mean value of a sample was obtained from 3 readings for exterior color and 3 readings for interior color.

Sensory evaluation: Sensory analysis was conducted using a trained test panel. The taste panel members were primarily employees and students of Iowa State University who had participated in previous sensory panels for frankfurters. Panelists underwent a training sessions before the beginning of the first test session on day 0. Retraining was done after 45 and 90 days of storage of the frankfurters. Five frankfurters from each treatment were placed into the boiling water in covered pans, taken off the burner and left to sit for 7 minutes. Of each of the 5 frankfurter samples, one frankfurter was cut in half. One-half was reserved for color and texture evaluation. The frankfurters were served to the panelist by cutting them into ½ inch pieces. Each panelist was given two randomly selected pieces labeled with a three-digit random number. The reserved half of the frankfurter was cut into three pieces which were placed with cut side up in the center of a white plate for evaluation of color and uniformity of texture.

Statistical analysis: Results, where applicable, were analyzed for significant differences using ANOVA (P,0.05) with StarView 5.0.1 for Window manufactured by SAS institute Inc., copyright 1992-1998. A completely randomized design (Cochran, W. G. and Cox, G. M. 1992. Experimental Designs. 2nd ed. John Wiley & Sons, Inc., New York, N.Y.) consisting of 8 formulations was used. The Statistical Analysis System (SAS Institute 1991) was used to determine means, standard errors and analysis of variance.

Attributes evaluated were cured hot dog aroma (none to intense), interior firmness (not firm to firm), interior cohesiveness (not cohesive to cohesive), juiciness (not juicy to juicy), cured hot dog flavor (none to intense), rancidity (none to intense), cured meat color (none to intense) and interior texture uniformity (not uniform to uniform). Each attribute was scored using a 9-point hedonic scale, with absence of the attribute being equal to 1 and intense presence being 9. For each attribute, panelists were asked to mark, an X on one of the nine boxed (first box=none/low and the ninth box=intense/high) that best described the sample.

Panelists were seated in a sensory booths equipped with red light and used sensory computer software Compusense to record their responses. Six samples, containing 0% (control), 1%, 1.5%, 2%, 3%, and 3.5% rice bran were presented warm in a covered container simultaneously to the 9 panelist. The panelist were asked to shake the container to release volatile aromatic compounds and immediately rate the sample for cured hot dog aroma. The panelist then placed one piece of the frankfurter between their molars and bit down to rate the interior firmness of the sample. With continued chewing, each panelist evaluated the cohesiveness of the interior, juiciness, cured hot dog flavor and the level of rancidity. The panelist consumed water at 20° C. between samples. Panelists then moved to an adjacent room where they rated the interior of each frankfurter to cured meat color and for uniformity of texture under white light.

TABLE 1
Composition of frankfurter formulations with
different amounts of stabilized rice bran.

| | | 0.5% | 1% | 1.5% | 2% | 2.5% | 3% | 3.5% |
|---|---|---|---|---|---|---|---|---|
| Component | Control | SRB | SRB | SRB | SRB | SRB | SRB | SRB |
| PORK 90's | 25.64 | 25.64 | 25.64 | 25.64 | 25.64 | 25.64 | 5.64 | 25.64 |
| Beef 50's | 44.50 | 44.50 | 44.50 | 44.50 | 44.50 | 44.50 | 44.50 | 44.50 |
| Water | 22.00 | 22.00 | 22.00 | 22.00 | 22.00 | 22.00 | 22.00 | 22.00 |
| Salt | 2.25 | 2.25 | 2.25 | 2.25 | 2.25 | 2.25 | 2.25 | 2.25 |
| K Lactate/ | 2.00 | 2.00 | 2.00 | 2.00 | 2.00 | 2.00 | 2.00 | 2.00 |
| Na | | | | | | | | |
| diacetate | | | | | | | | |
| Corn syrup | 0.91 | 0.91 | 0.91 | 0.91 | 0.91 | 0.91 | 0.91 | 0.91 |
| solids | | | | | | | | |
| Flavorings | 2.25 | 2.25 | 2.25 | 2.25 | 2.25 | 2.25 | 2.25 | 2.25 |
| (Spice) | | | | | | | | |
| Phosphate | 0.40 | 0.40 | 0.40 | 0.40 | 0.40 | 0.40 | 0.40 | 0.40 |
| Erythrobate | 0.04 | 0.04 | 0.04 | 0.04 | 0.04 | 0.04 | 0.04 | 0.04 |
| Nitrite | 0.01 | 0.01 | 0.01 | 0.01 | 0.01 | 0.01 | 0.01 | 0.01 |
| Rice Bran | 0.00 | 0.05 | 1.00 | 1.50 | 2.00 | 2.5 | 3.0 | 3.5 |
| Total | 100.00 | 100.50 | 101.00 | 101.50 | 102.00 | 102.5.0 | 103.00 | 103.50 |

As shown in FIG. 1, proximate analysis revealed that the percent of fat and protein in the eight samples did not differ significantly between one another (P<0.05). Compared to the control, the moisture content for formulations with 0.5%, 1.0%, 1.5% and 2.0% SRB did not differ significantly between one another. Formulations with 2.5%, 3.0% and 3.5% SRB had significantly less moisture compared to the control. The moisture difference was generally progressive with the 3.5% SRB treatment having about 3% less moisture than the control.

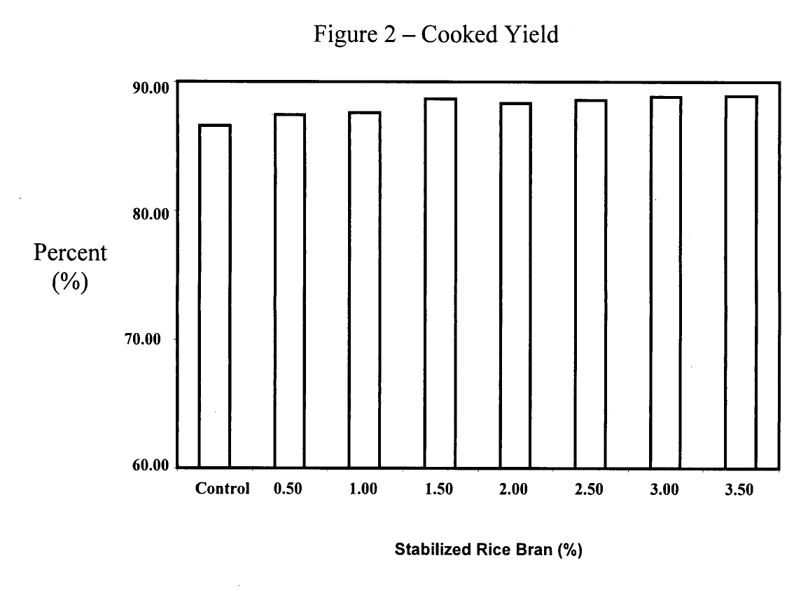

The cooked yields for the 0.5% and 1.0% SRB formulations were numerically higher, but not statistically different from the control. All other formulations (1.5%-3.5%) had statistically higher cooked yields relative to the control formulation (FIG. 2).

TABLE 2
Purge rate for control and experimental frankfurter formulations
with different amounts of stabilized rice bran.

| | | | | | Mean | Mean |
|---|---|---|---|---|---|---|
| | Mean | Mean | Mean | Mean | Week | Week |
| | Week 2 | Week 4 | Week 6 | Week 8 | 10 | 12 |
| Sample | Purge | Purge | Purge | Purge | Purge | Purge |
| CONTROL | 0.98 | 1.06 | 1.02 | 0.93 | 0.91 | 0.92 |
| 0.5% Rice bran | 0.89 | 0.89 | 0.83 | 0.83 | 0.67 | 0.69 |
| 1.0% Rice bran | 0.83 | 0.84 | 0.84 | 0.81 | 0.74 | 0.67 |
| 1.5% Rice bran | 0.82 | 0.74 | 0.86 | 0.71 | 0.72 | 0.62 |
| 2.0% Rice bran | 0.86 | 0.70 | 0.84 | 0.72 | 0.70 | 0.72 |
| 2.5% Rice bran | 0.82 | 0.70 | 0.84 | 0.71 | 0.67 | 0.69 |
| 3.0% Rice bran | 0.77 | 0.70 | 0.77 | 0.67 | 0.68 | 0.59 |
| 3.5% Rice bran | 0.67 | 0.63 | 0.71 | 0.60 | 0.57 | 0.47 |

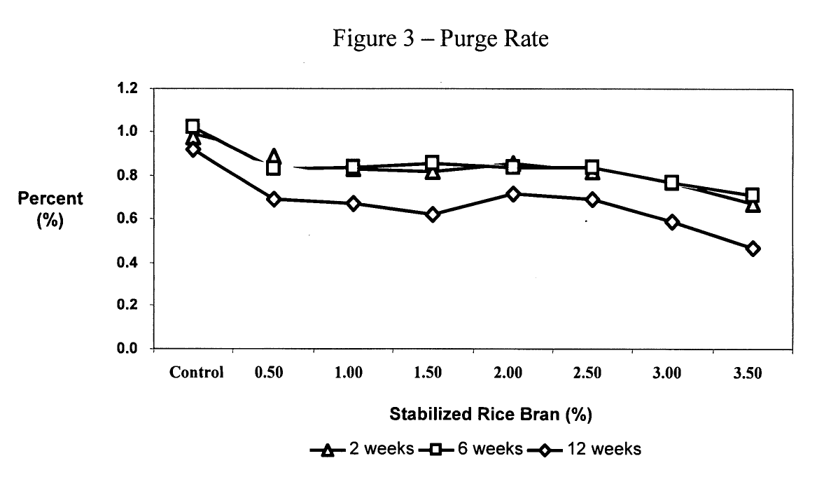

Purge measurements for all formulations were performed at two week intervals throughout the 12 week hold time. Table 2 shows data for week 2, 4, 6, 8, 10, and 12. FIG. 3 shows the data for weeks 2, 6, and 12 for clarity. In general, a trend was observed in which reduced purge was observed as the percent of SRB increased. At week 2, the 3.5% SRB formulation had a significantly lower purge compared to the control, while all other SRB formulations maintained a purge value not significantly different from the control. At week 4, again the 3.5% SRB treatment showed a lower purge than the control while the other SRB formulations were not significantly different. At week six, all SRB formulations were not significantly different from the control. By week 8 the 3.0% and 3.5% SRB formulations had significantly lower purge values compared to the control while the lower percent SRB formulations maintained a purge value not significantly different from the control. At week 10 none of the SRB formulations were significantly different from the control in purge value and by week 12 the 1.5%, 3.0% and 3.5% SRB formulations had significantly less purge than the control while the 0.5%, 1.0%, 2.0% and 2.5% SRB formulations maintained a purge not significantly different from the control.

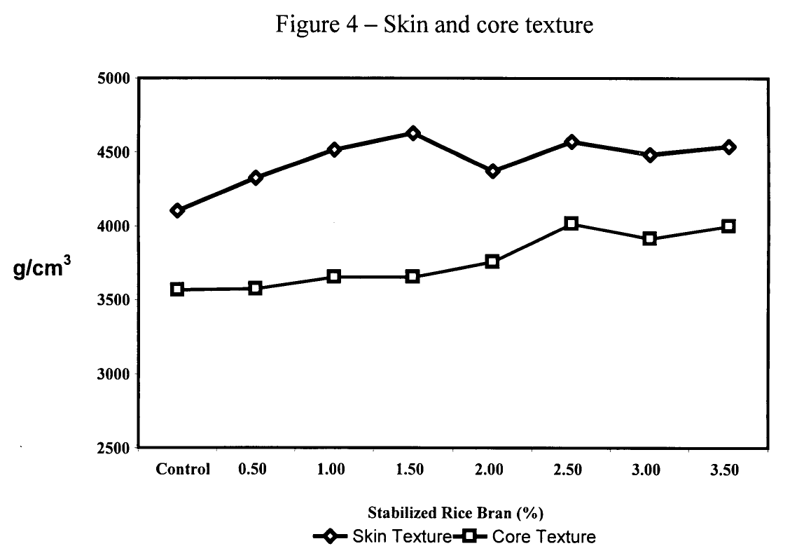

With regard to skin and core textural evaluations, measurements were obtained within one week of manufacture. Neither the skin nor the core texture was significantly different in the SRB formulations from the control (FIG. 4).

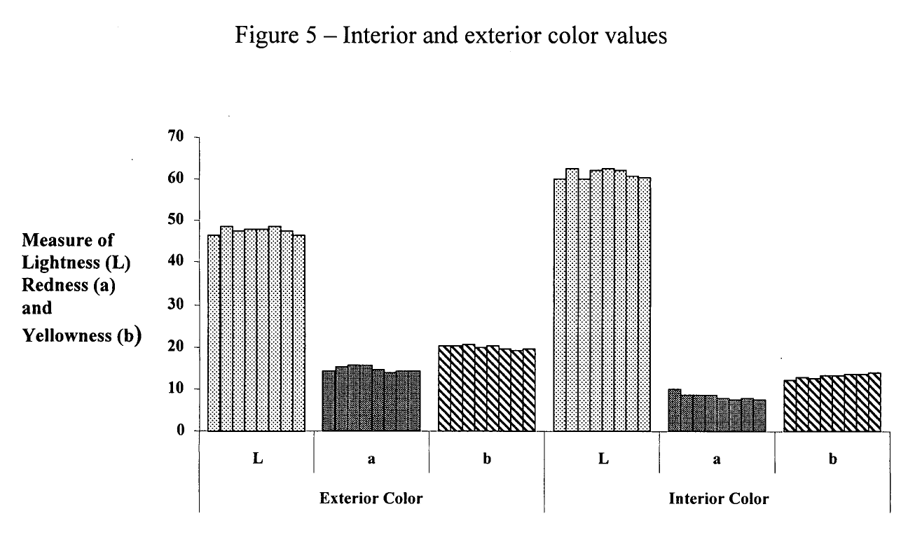

Interior and exterior color values were determined using an optical sensor after standardization on a white and black color plate. FIG. 5 shows the interior and exterior color values for the eight formulations. The “L” values are measures of “lightness” extending from 0 (black) to 100 (white) while the positive “a” values are measures of redness while the positive “b” values are measures of yellowness. The exterior lightness value “L”, exterior “a” (redness) values and the interior “L” values for all the SRB formulations were not significantly different from the corresponding control values. While there were some statistical differences among the values for exterior “b” (yellowness), none of these differences were statistically significant. Interior “a” values (redness) were not significantly different from the control at the 0.5%, 1.0% and 1.5% SRB levels, but the 2%-3.5% SRB formulations were significantly lower vs. control “a” values. Interior “b” values (yellowness) were not significantly different at the 0.5%-2% SRB inclusion levels however the 2.5%-3.5% SRB formulations showed significantly higher “b” values compared to the control.

As previously mentioned, the sensory evaluations of the frankfurter products were accomplished using a trained sensory panel whose evaluations were based on a hedonic scale from 1 to 9 with 1 indicating the absence of the attribute and 9 indicating an intense presence of the attribute. Evaluations were conducted on all eight formulations on Day 1, Day 45 (six weeks) and again on Day 90 (twelve weeks). Eight different frankfurter characteristics were evaluated by the sensory panel: Cured Meat Aroma, Cured Meat Flavor, Cured Meat Color, Interior Firmness, Interior Cohesiveness, Interior Uniformity, Juiciness and Rancidity.

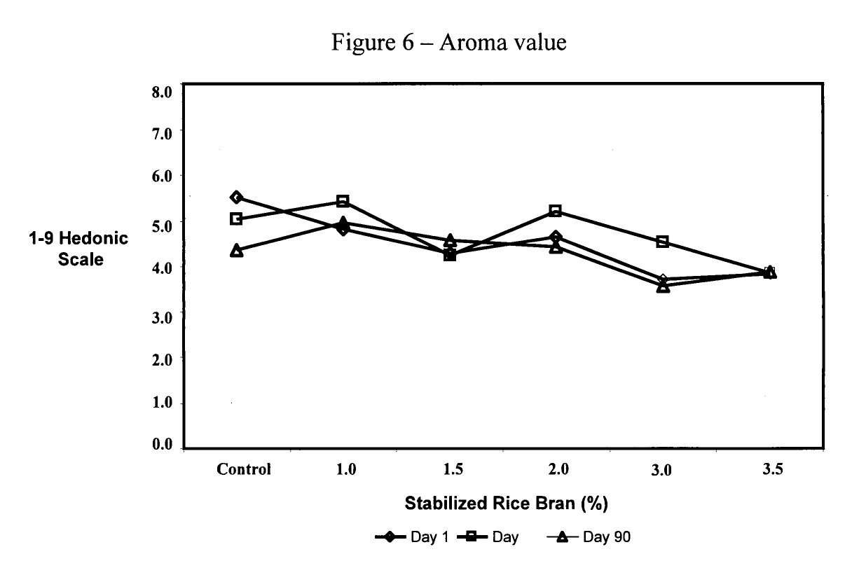

Cured Meat Aroma—On Day 1, panelists were unable to detect significant (P>0.05) differences in cured meat aroma in formulations with SRB up to 2.0% compared to the control (FIG. 6). They did detect lower (P<0.05) cured meat aroma in formulations with 3.0 and 3.5% SRB. On day 45 panelists could not detect any significant (P>0.05) differences in cured meat aroma in formulations containing 1.0, 2.0 and 3.0% SRB compared to the control. They found significantly (P<0.05) lower cured meat aroma for formulations containing 1.5 and 3.5% SRB compared to the control. By Day 90 panelists were unable to detect any significant (P>0.05) differences in cured meat aroma between any of the SRB-supplemented samples compared to the control.

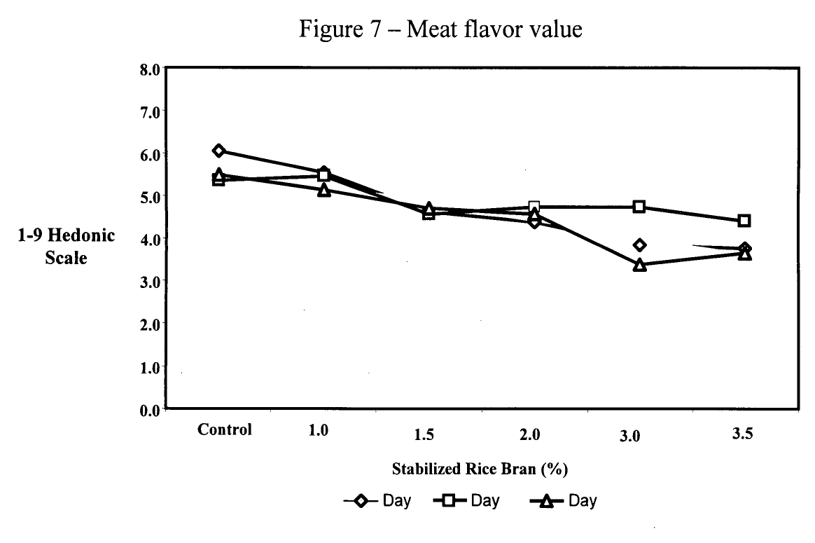

Cured Meat Flavor—Initial Day 1 testing found that the panelists found no significant differences in flavor compared to the control for formulations containing SRB up to 2.0%. The panelists found significantly (P<0.05) less cured meat flavor for the 3.0 and 3.5% SRB formulations. At Day 45, no significant differences (P>0.05) were noted for formulations containing 1.0, 2.0 and 3.0% SRB compared to the control but panelists did find lower cured meat flavor vs. control in formulations containing 1.5 and 3.5% SRB. After 90 days, panelists found no significant (P>0.05) difference between the control and formulations containing up to 2.0% SRB. They did, however, find significantly (P<0.05) less cured meat flavor in the 3.0 and 3.5% SRB formulations (FIG. 7).

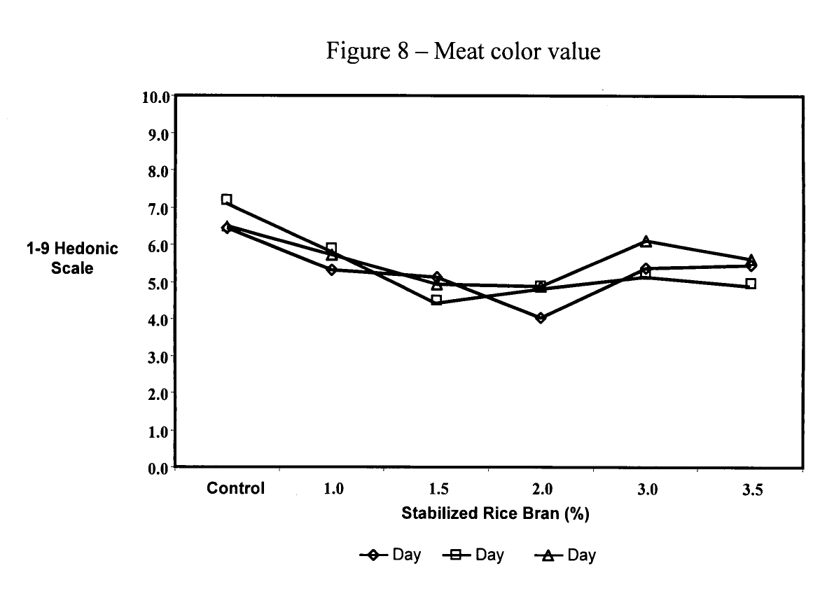

Cured Meat Color—Panelists on Day 1 found that, with the exception of the 2% SRB treatment, there were no significant (P>0.05) differences in color between the control and the other SRB formulations. The 2.0% SRB treatment was significantly different (P<0.05) from the control, but not from the other SRB formulations. At six weeks (Day 45) the 1% SRB formulation was not significantly (P>0.05) different from the control, whereas the other formulations were judged to have significantly (P<0.05) less cured meat color as compared to the control. After 12 weeks (90 days) panelist could detect no significant (P>0.05) differences in color for any of the SRB formulations when compared to the control color (FIG. 8).

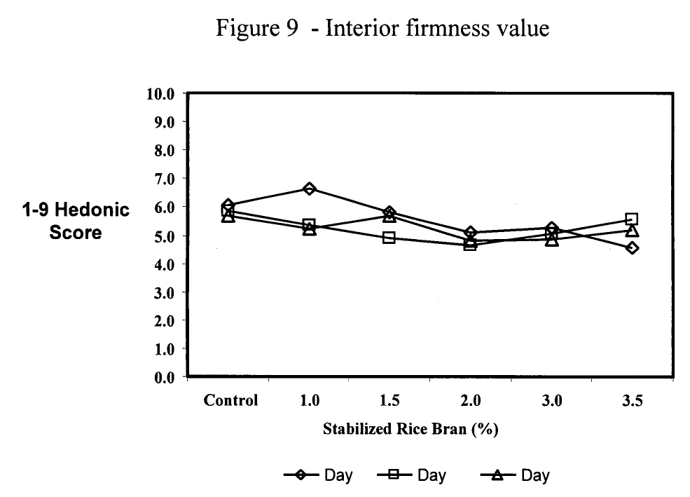

Interior Firmness—No significant (P>0.05) differences were observed by the panel members when evaluating Interior Firmness of the SRB formulations relative to the control product at Day 1, Day 45 and Day 90 (FIG. 9).

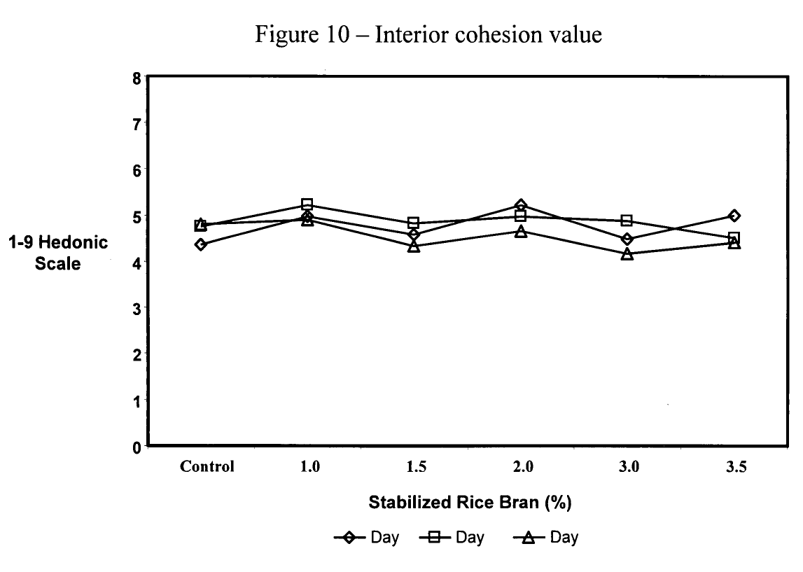

Interior Cohesiveness—For Day 1, Day 45 and Day 90 evaluations, panelist found no significant (P>0.05) differences comparing the SRB formulations and the control product (FIG. 10).

Interior Uniformity—Panelist could detect no significant (P>0.05) differences between any of the SRB formulations and the control product at Day 1 and at Day 90. At Day 45, the panel found no significant (P>0.05) difference between the control and the 1.0, 2.0 and 3.0% SRB formulations. They did find that the 1.5 and 3.5% SRB formulations were significantly different in interior uniformity compared to the control (FIG. 1).

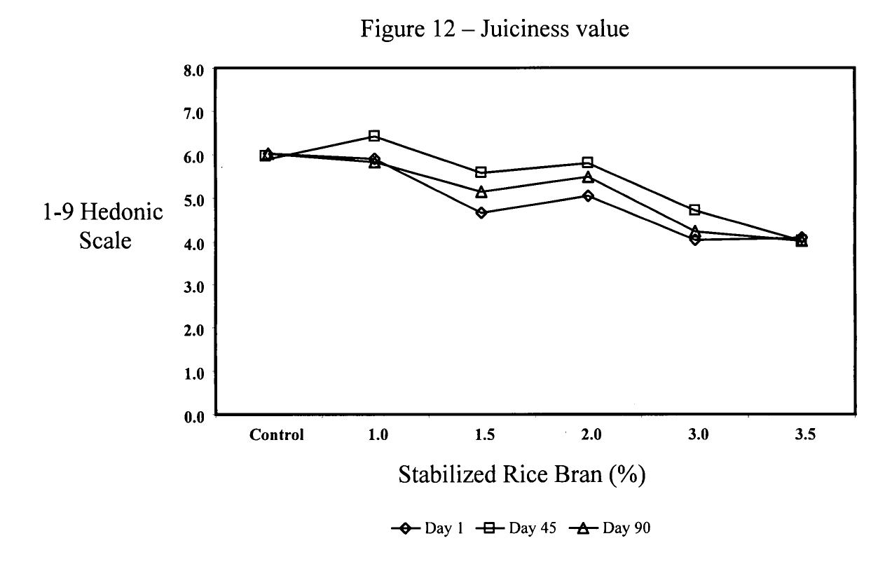

Juiciness—At initial testing on Day 1 the panel found no significant differences in juiciness between the control and all SRB formulations. The same held true for all SRB formulations tested on Day 90. On Day 45, panelists found that the formulation containing 3.5% SRB was significantly less juicy compared to the control but found no significant differences in juiciness for any of the other SRB formulations (FIG. 12).

Rancidity—Having evaluated all products at Day 1, Day 45 and Day 90, panelists found no significant differences in rancidity when comparing the SRB formulations with the control.

The above results support the following advantages for using SRB as a stand alone meat extender:

(1) The cook yield for frankfurters containing SRB at levels of 1.5-3.5% was significantly higher than that of the control product. Increased yield is economically beneficial to the meat manufacturer.

(2) After weeks two and four of refrigerated storage, the purge was significantly lower in the product containing 3.5% SRB compared to the control product. After 8 weeks of refrigerated storage, purge was significantly lower in the 3.0 and 3.5% SRB formulations compared to the control. After 12 weeks of refrigerated storage, purge was significantly lower in the 1.5, 3.0 and 3.5% SRB formulations relative to the control product. A lower purge rate is also economically beneficial to the meat manufacturer.

(3) While there were some differences in color the characteristics of the 2.5, 3.0 and 3.5% SRB formulations compared to the control, the differences were small and could, in all likelihood, be remedied by adjusting the amount of food coloring/flavoring added to the meat formulation.

(4) Frankfurter formulations containing up to 3.5% SRB had no detectable effect on the interior firmness, cohesiveness or rancidity of the products.

(5) Only the highest SRB usage rate (3.5%) had a significant effect on the juiciness of the formulated frankfurter after 45 days. At all other evaluation times, no effect on the juiciness of the product was detected.

Overall, it is clear that stabilized rice bran can be used as a cost-effective, extender ingredient in comminuted meat products to increase cooked product yield, reduce purge and improve texture, without significant adverse effects on the sensory attributes of the consumed product. In addition, the added nutritional benefits of stabilized rice bran are another added benefit for use in meat and meat analog products.

### Example 2

### Use of Stabilized Rice Bran as an Extender in Chicken Nugget Preparation

In a second example of the present invention, the use of stabilized rice bran as a meat extender in chicken nuggets, a coarse chopped meat product, is provided. Chicken breast meat was ground through ½″ plate. SRB and other ingredients were added to the ground chicken meat at various concentrations and thoroughly mixed. The resulting mixture was reground through a ⅜″ plate and stuffed into a 1.5″ casing and frozen. The resulting nugget flanks were band-sawed with a thickness of ½″. The resulting pieces were pre-dusted, battered and breaded. The resulting product was fried in oil at 400° for 30 seconds and cooked in convection oven at 350° F. until the internal temperature of 165° F. were achieved. The chicken pieces were blast frozen at −40° F. until completely frozen. Reconstitution was done in oven for evaluation.

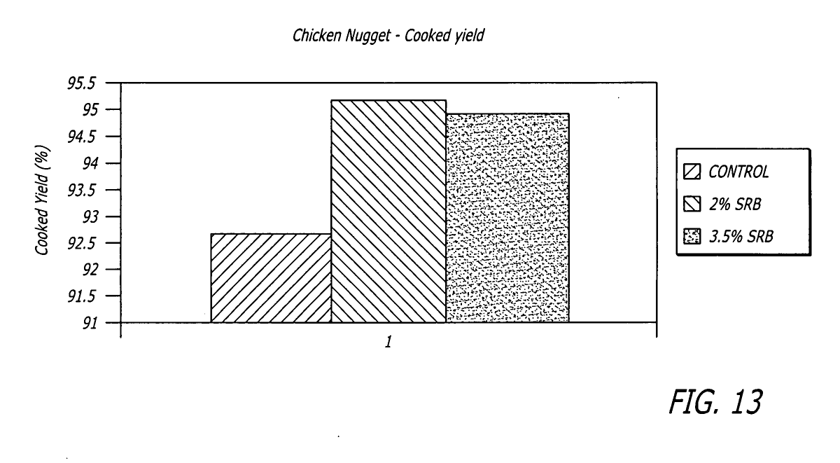

Tables 3, 4, and 5, show the composition of chicken nuggets prepared with 0%, 2.0% and 3.5% SRB as meat extender respectively. The results shown in FIG. 13 indicate, utilizing SRB at 2% and 3.5% in chicken nuggets to replace breast meat resulted in increased cooked yields without significantly altering finished product quality.

The present invention has been described above with reference to exemplary embodiments. However, those skilled in the art having read this disclosure will recognize that changes and modifications may be made to the exemplary embodiments without departing from the scope of the present invention.

TABLE 3
Composition of control chicken nugget with no stabilized rice bran.

| | Ingredient Composition | | | | Contribution to Formula | | |
|---|---|---|---|---|---|---|---|
| Component | Moisture | Fat | Protein | Usage (%) | Moisture | Fat | Protein |
| Chicken Breast | 75.00 | 1.28 | 22.54 | 89.70 | 6727.50 | 114.82 | 2021.84 |
| Water | 100.00 | 0.00 | 0.00 | 8.40 | 840.00 | 0.00 | 0.00 |
| Salt | 0.00 | 0.00 | 0.00 | 1.08 | 0.00 | 0.00 | 0.00 |
| Spices | 0.00 | 0.00 | 0.00 | 0.42 | 0.00 | 0.00 | 0.00 |
| Sodium Phosphate | 0.00 | 0.00 | 0.00 | 0.40 | 0.00 | 0.00 | 0.00 |
| Stabilized Rice Bran | 6.00 | 21.00 | 14.00 | 0.00 | 0.00 | 0.00 | 0.00 |
| Total | | | | 100 | 7567.50 | 115.82 | 202184 |

TABLE 4
Composition of chicken nugget with 2% stabilized rice bran.

| | Ingredient Composition | | | | Contribution to Formula | | |
|---|---|---|---|---|---|---|---|
| Component | Moisture | Fat | Protein | Usage (%) | Moisture | Fat | Protein |
| Chicken Breast | 75.00 | 1.28 | 22.54 | 89.70 | 6577.50 | 112.26 | 1976.76 |
| Water | 100.00 | 0.00 | 0.00 | 8.40 | 840.00 | 0.00 | 0.00 |
| Salt | 0.00 | 0.00 | 0.00 | 1.08 | 0.00 | 0.00 | 0.00 |
| Spices | 0.00 | 0.00 | 0.00 | 0.42 | 0.00 | 0.00 | 0.00 |
| Sodium Phosphate | 0.00 | 0.00 | 0.00 | 0.40 | 0.00 | 0.00 | 0.00 |
| Stabilized Rice Bran | 6.00 | 21.00 | 14.00 | 2.00 | 12.00 | 42.00 | 28.00 |
| Total | | | | 100 | 7429.50 | 154.26 | 2004.76 |

TABLE 5
Composition of chicken nugget with 3.5% stabilized rice bran.

| | Ingredient Composition | | | | Contribution to Formula | | |
|---|---|---|---|---|---|---|---|
| Component | Moisture | Fat | Protein | Usage (%) | Moisture | Fat | Protein |
| Chicken Breast | 75.00 | 1.28 | 22.54 | 86.20 | 6465 | 110.34 | 1942.95 |
| Water | 100.00 | 0.00 | 0.00 | 8.40 | 840.00 | 0.00 | 0.00 |
| Salt | 0.00 | 0.00 | 0.00 | 1.08 | 0.00 | 0.00 | 0.00 |
| Spices | 0.00 | 0.00 | 0.00 | 0.42 | 0.00 | 0.00 | 0.00 |
| Sodium Phosphate | 0.00 | 0.00 | 0.00 | 0.40 | 0.00 | 0.00 | 0.00 |
| Stabilized Rice Bran | 6.00 | 21.00 | 14.00 | 3.50 | 21.00 | 73.50 | 49.00 |
| Total | | | | 100 | 7429.50 | 154.26 | 2004.76 |

What is claimed is:

1. A meat product composition, wherein a suitable portion of the meat is replaced with a high protein, high fiber extender, the composition comprising a ground meat and a bran material derived from a cereal grain as the extender.

2. The meat product composition of claim 1, wherein the bran material is a stabilized rice bran.

3. The meat product composition of claim 1 wherein the bran material is a defatted rice bran material.

4. The meat product composition of claim 1 wherein the bran material is a stabilized wheat bran.

5. The meat product composition of claim 1, wherein the extender comprises a stabilized rice bran and a stabilized wheat bran.

6. The meat product composition of claim 1, wherein the meat and the bran material are in the ratio of 90:10 in weight basis.

7. The meat product composition of claim 1, wherein the rice bran is provided in a range from about 0.5% to about 3.5% by weight.

8. A meat analog product composition comprising a bran material derived from a cereal grain.

9. The meat analog product composition of claim 7, wherein the bran material is a stabilized rice bran.

10. The meat analog product composition of claim 7, wherein the bran material is a defatted rice bran.

11. The meat analog product of claim 7, wherein the bran material is a stabilized wheat bran.

12. The meat analog product of claim 7, wherein the bran material comprises a stabilized rice bran and a stabilized wheat bran.
